(19) United States
(12) Patent Application Publication
(10) Pub. No.: US 2023/0297941 A1
(43) Pub. Date: Sep. 21, 2023

(54) PACKAGE DELIVERY SYSTEM AND METHOD

(71) Applicant: Joel Hale, Indianapolis, IN (US)

(72) Inventor: Joel Hale, Indianapolis, IN (US)

(21) Appl. No.: 18/182,096

(22) Filed: Mar. 10, 2023

Related U.S. Application Data
(60) Provisional application No. 63/319,848, filed on Mar. 15, 2022.

(51) Int. Cl. G06Q 10/0835; G06Q 10/0833

(52) U.S. Cl. CPC G06Q 10/08355; G06Q 10/0833

(57) ABSTRACT

Embodiments of the present disclosure may include a method of delivering a package by a courier from an origination location to a delivery address, the method including providing a delivery system including an origination system in communication with a courier device. Embodiments may also include receiving, by the origination system, a notification that the courier may be within a pre-defined geographical area of the origination location. Embodiments may also include transmitting, by the origination system, an alert to the courier device that a package may be available for a delivery at the origination location. Embodiments may also include accepting, by the courier, the package for delivery. Embodiments may also include receiving, by the origination system, a confirmation that the courier has accepted the delivery. Embodiments may also include confirming, by the delivery system, an arrival of the courier at the origination location.

### CROSS-REFERENCE TO RELATED APPLICATIONS

This application claims the benefit of U.S. Provisional Application No. 63/319,848, filed on Mar. 15, 2022. The entire disclosure of the above application is incorporated herein by reference.

### FIELD

The present technology includes articles of manufacture and processes that relate to a package delivery system and method, including a last mile package delivery system and method.

### INTRODUCTION

This section provides background information related to the present disclosure which is not necessarily prior art.

Last mile delivery refers to the movement of a good from a transportation hub or warehouse to its final destination. In most cases, the final destination is a delivery to an end customer. Last mile delivery aims to deliver items to a customer as quickly as possible while minimizing shipping costs to the customer and the company. The same technology that enables customers to purchase products with the click of a button comes with the expectation that the product will be delivered quickly. Fast, efficient, and reliable order fulfillment is increasingly the key to maintaining customer satisfaction and is often the last impression that a customer may have of a business transaction.

One issue with last mile delivery is that, while customers demand low cost and fast deliveries, the last mile is often the most expensive part of the supply chain. In fact, the last mile of delivery may amount to more than 50% of the total cost of shipping a product. Factors such as labor costs, improper route optimization, lack of transparency, and bad delivery infrastructure may all add up. In addition, last mile deliveries may suffer delays, loading failures, loss of items, wrong addresses, and stolen packages. When a package goes missing, the delivery partner and the end customer may be left with little recourse and little idea what went wrong.

Companies may be able to outsource or crowdsource deliveries by connecting with non-professional couriers to finish a last mile delivery. However, as last mile deliveries are increasingly handled by non-professional couriers, it has become more important that these deliveries are visible and facilitate accountability.

Accordingly, there is a need for ways to ensure visibility for delivery customers and end to end accountability for delivery providers during a last mile delivery of an item.

### SUMMARY

In concordance with the instant disclosure, systems and methods that ensure visibility for delivery customers and end to end accountability for delivery providers during a last mile delivery of an item, are surprisingly discovered.

Various embodiments of the present technology may include articles of manufacture, systems, and processes that relate to package delivery. A delivery system may include identifying a courier within a pre-defined geographical area. An alert may then be sent that a delivery is available at an origination location. The delivery may include multiple deliveries to different locations. The delivery may include a food item or a nonfood item. A confirmation that a courier has accepted the delivery may be received at the origination location. After the courier arrives at the origination location, it is verified that the courier has arrived and a delivery route for the courier may be populated. In certain embodiments, the route may be optimized based on one or more changing conditions. In still certain embodiments, as the route is populated, it may be viewable by a customer.

Once the courier has received the delivery item, an exit of the courier from the origination location may be verified. Each delivery may be verified as finished at a delivery location. Verifying a finished delivery at a location may include taking a geographical time stamp including a latitudinal and longitudinal coordinate at the delivery location. After completion of delivery, a return of the courier may be confirmed at the origination location. The method may further include transferring payment to the courier upon confirming the return of the courier at the origination location.

In certain embodiments, a method of delivering a package by a courier from an origination location to a delivery address may include providing a delivery system including an origination system in communication with a courier device. The origination system may receive a notification that the courier is within a pre-defined geographical area of the origination location. In response, the origination system may send an alert to the courier device that a package is available for a delivery at the origination location. The courier may accept the package for delivery and the origination system may receive a confirmation that the courier has accepted the delivery. The delivery system may confirm an arrival of the courier at the origination location. Upon confirmation of the courier at the origination location, the courier may acquire the package and a delivery route for courier may be populated based on the delivery address.

Embodiments may also include confirming, by the delivery system, a departure of the courier and the package from the origination location. The courier may then transport the package to the delivery address. A delivery of the package at the delivery address may be verified. After delivery of the package at the delivery address the courier may return to the origination location.

In certain embodiments, the delivery system may further include a customer device. The customer device may be in communication with the delivery system. The delivery system may be configured to send an alert to the customer device that the package has been delivered to the delivery address. In certain embodiments, the alert may include a geographical time stamp. In certain embodiments, the courier may acquire multiple packages for delivery. The delivery route may be optimized based on multiple delivery addresses of the multiple packages for delivery.

In certain embodiments, the courier may scan a code affixed to the package to acquire the package. The code affixed to the package may include a delivery address of the package, such that the delivery route may be populated as the code affixed to the package is scanned. An arrival of the courier at the origination location may include the courier device communicating a location of the courier device at the origination location to the origination system. In certain embodiments, the courier may be pre-approved to deliver the package by the delivery system prior to receiving the notification by the origination system that a package may be available for delivery at the origination location. The courier may be selected from a pool of pre-approved couriers. The delivery route may be updated based on an environmental condition of the delivery route.

In certain embodiments, the delivery system may populate the delivery route. Alternatively, the courier device may populate the delivery route. A payment may be transferred to the courier device upon return of the courier at the origination location after delivery of the package at the delivery address.

A system for facilitating a delivery of a package by a courier from an origination location to a delivery address may include a courier identification module in communication with a courier device. The courier identification module may be configured to receive a notification that the courier device is within a pre-defined geographical area of the origination location. An alerting module may be configured to transmit an alert to the courier device that a package is available for a delivery at the origination location. Embodiments may also include a confirmation module configured to receive an acceptance by the courier device of the package for delivery. In some embodiments, an acceptance confirmation module may be configured to confirm that the courier has accepted the package for delivery. An arrival confirmation module may be configured to confirm the arrival of the courier at the origination location. Upon arrival of the courier at the origination location, the courier may take possession of the package. A delivery route populating module may be configured to populate a delivery route for the courier based on a delivery address of the package.

In certain embodiments, a departure confirmation module may be configured to confirm a departure of the courier and the package from the origination location. Upon confirmation of departure from the origination location, the courier may transport the package to the delivery address. A delivery verification module may be configured to verify a delivery of the package at the delivery address. A return confirmation module may be configured to confirm a return of the courier at the origination location after delivery of the package at the delivery address.

The courier device may be selected from a group including a smartphone, a tablet, a watch, a portable computing device, a transceiver, and combinations thereof. The package may include one of a food product and a non-food product. The system for facilitating a delivery of a package by a courier from an origination location to a delivery address may also include a payment module configured to transfer a payment to the courier device upon return of the courier at the origination location after delivery of the package at the delivery address.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a flowchart illustrating a method of delivering a package, according to an embodiment of the present disclosure.

FIG. 1B is a flowchart extending from FIG. 1A and further illustrating the method of delivering a package, according to an embodiment of the present disclosure.

FIG. 2 is a block diagram illustrating a system, according to an embodiment of the present disclosure.

FIG. 3 is a system for facilitating a delivery of a package by a courier from an origination location to a delivery address, according to an embodiment of the present disclosure.

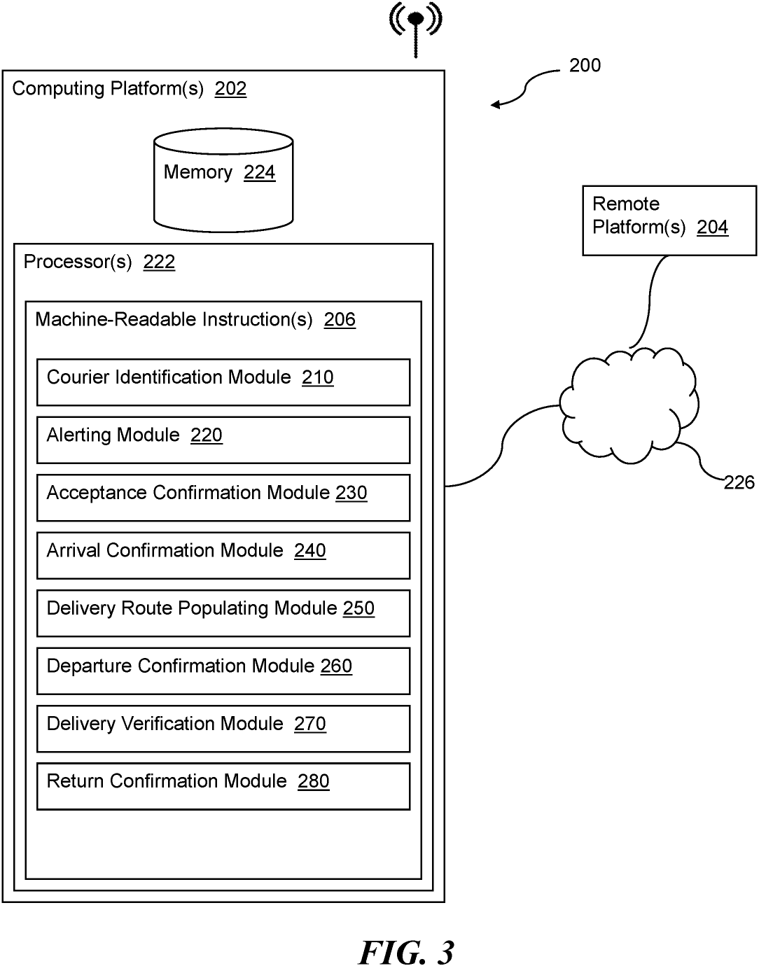

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to delivery systems and methods. These delivery systems and methods provide a customer or company with a “day of flexibility” to complete the shipments for a given day. For example, a courier may receive an alert indicating that a package is available for pick up. When the courier accepts the package, the courier may be confirmed. The courier then travels to the required package origination location. Upon arrival, the courier may be confirmed, or “scanned-in” and may be assigned the package for delivery.

The package may be scanned or otherwise claimed by the courier. As the package is scanned, a delivery route may be populated and optimized. The route may be determined according to the delivery address of the package. In certain embodiments, the scan may extract package data including the delivery address from one or more codes, such as a quick response (QR) code, or other similar scannable code affixed to the one or more packages. As the route is populated and uploaded, it may be viewed by the customer. After scanning the assigned packages, the courier may load the packages to make a delivery. In certain embodiments, the courier may scan out to indicate leaving the pickup location before making the deliveries. The courier may deliver the package using an appropriately desired method. For example, the courier may deliver the package using a bike, a truck, a passenger car, a box truck, and other appropriately desired methods. In certain embodiments, the courier may deliver the package by walking the delivery route.

As the courier makes a delivery, the courier may take a picture and scan the package to mark it as delivered. A geographical time stamp with the longitudinal and latitudinal coordinates of the drop off location may indicate delivery confirmation. After the courier has completed delivering the assigned packages, the courier may return to an origination location of the package.

Upon returning to the origination location, the courier may be “scanned-out” to confirm that the package has been delivered and may take payment for the day. In certain embodiments, the courier may communicate using a smart device. Delivery may include package delivery, restaurant delivery, and delivery of other goods. In particular, the system enables the delivery courier to pick up from one location and complete multiple deliveries at different locations.

The system may include one or more hardware processors configured by machine-readable instructions for optimizing a delivery system. The system may identify one or more pre-approved couriers within a geographical area. Based on the one or more identified couriers, the system sends an alert that a delivery is available at an origination location. Then, a confirmation may be received that a courier accepts the delivery at the origination location.

The system may also confirm that the courier has accepted the delivery at the origination location. An arrival of the courier at the origination location may be verified. The system, using machine-readable instructions, may be configured to populate a delivery route for the courier based on the delivery. An exit of the courier from the origination location may be confirmed. The system may also verify a finished delivery at a location. After completion of the deliveries, the courier may return to the origination location.

Advantageously, the present technology verifies a courier when receiving one or more packages for delivery, at drop-off of the one or more packages at a correct delivery location, and when the courier returns to the package origination location to confirm that all deliveries have been made. In particular, the present technology may prevent lost and stolen deliveries by monitoring the delivery of a package at all stages, including after the package is delivered. As such, the present technology has many advantages.

Example embodiments of the present technology are provided with reference to the several figures enclosed herewith.

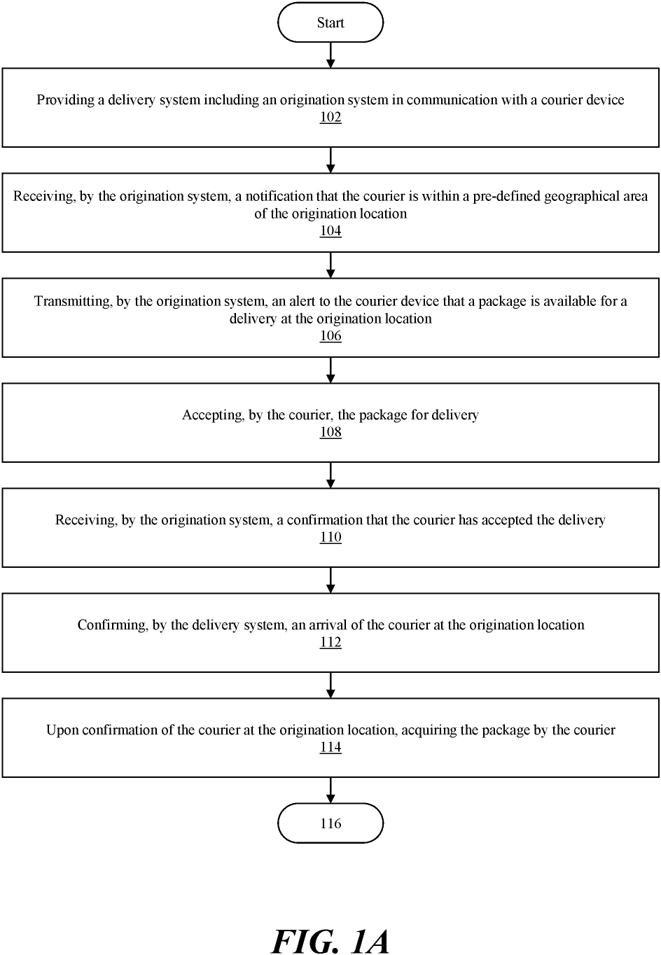

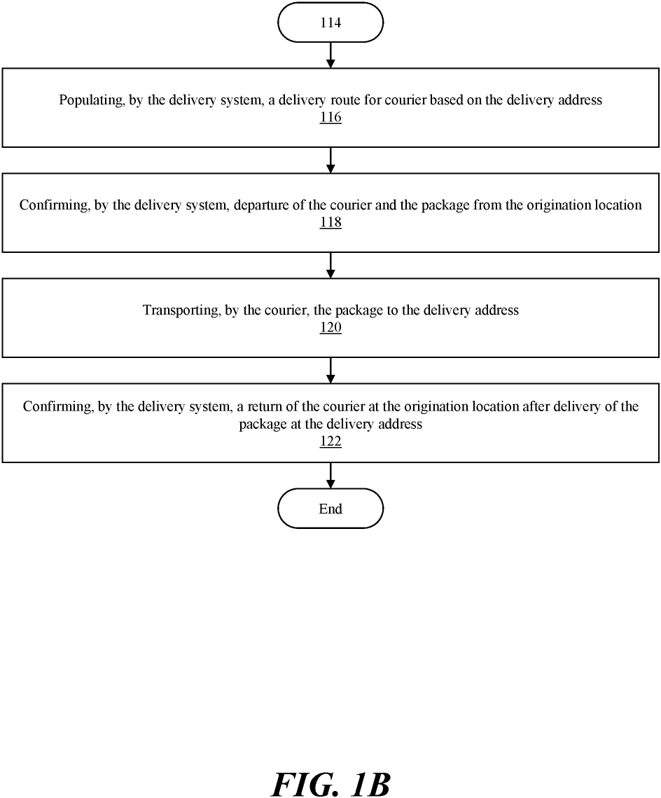

FIGS. 1A to 1B are flowcharts that describe a method of delivering a package, according to some embodiments of the present disclosure. At step 102, the method may include providing a delivery system including an origination system in communication with a courier device. At step 104, the method may include receiving, by the origination system, a notification that the courier is within a pre-defined geographical area of the origination location. At step 106, the method may include transmitting an alert to the courier device that a package is available for a delivery at an origination location.

In certain embodiments, at step 108, the courier may accept the package for delivery. At step 110, the origination system may receive a confirmation that the courier has accepted the delivery. At step 112, the method may include confirming, by the delivery system, an arrival of the courier at the origination location. At step 114, upon confirmation of the courier at the origination location, the package may be acquired by the courier.

In certain embodiments, at step 116, the method may include populating a delivery route for the courier based on the delivery address. A departure of the courier from the origination location may be confirmed at step 118. At step 120, the courier may transport the package to the delivery address. Then, at step 122, a return of the courier to the origination location after delivery of the package at the delivery address may be confirmed.

In certain embodiments, the delivery system may further include a customer device. The customer device may be in communication with the delivery system. In certain embodiments, the delivery system may be configured to send an alert to the customer device that the package was delivered to the delivery address. The alert may include a geographical time stamp. For example, the geographical time stamp may include a time of package delivery including a latitudinal and longitudinal coordinate at the delivery location.

In certain embodiments, the courier may acquire multiple packages for delivery and the delivery route may be optimized based on the multiple delivery addresses of the multiple packages for delivery. Acquiring the package may include scanning a code affixed to the package. In certain embodiments, the code affixed to the package may include a delivery address of the package. The code may include a QR code and other similar codes containing, relating, or translating to electronic information. In particular, the code may include any appropriately desired scannable code. In certain embodiments, the code may be scanned using the courier device. The delivery route may be populated as the code affixed to the package may be scanned. In certain embodiments, the delivery route may be updated based on an environmental condition of the delivery route. For example, the delivery route may be updated if there is a traffic jam, a storm, a power outage, or other environmental condition. In certain embodiments, the delivery system may populate the delivery route. Alternatively, an application of the courier device may populate delivery route.

Confirming an arrival of the courier at the origination location may include the courier device communicating a location of the courier device to the origination system. In certain embodiments, the courier may be pre-approved to deliver the package by the delivery system prior to receiving the notification by the origination system that a package may be available for delivery at the origination location. For example, the courier may use an application of the courier device to enter information which may be used to pre-approve the courier for package delivery. The courier may be selected from a pool of pre-approved couriers. In some embodiments, the delivery system may transfer a payment to the courier device upon return of the courier at the origination location after delivery of the package at the delivery address.

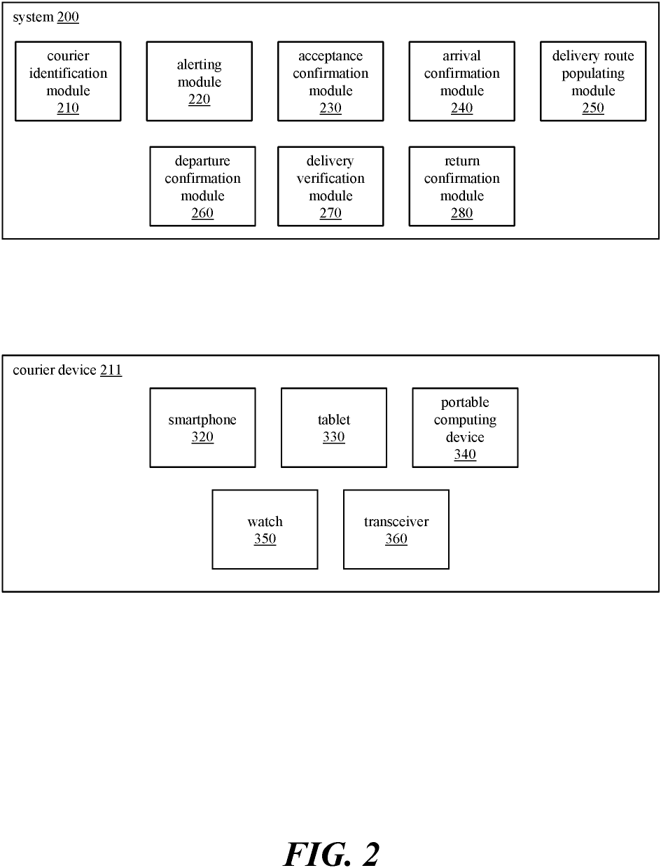

FIG. 2 is a block diagram that describes a system 200, according to some embodiments of the present disclosure. The system 200 may include a courier identification module 210 in communication with a courier device 211, an alerting module 220 configured to transmit an alert to the courier device 211 that a package may be available for a delivery at the origination location, an acceptance confirmation module 230 configured to receive an acceptance by the courier device 211 of the package for delivery, an arrival confirmation module 240 configured to confirm an arrival of the courier at the origination location, a delivery route populating module 250 configured to populate a delivery route for the courier based on a delivery address of the package, a departure confirmation module 260 configured to confirm a departure of the courier and the package from the origination location, a delivery verification module 270 configured to verify a delivery of the package at the delivery address, and a return confirmation module 280 configured to confirm a return of the courier at the origination location after delivery of the package at the delivery address.

In certain embodiments, the courier identification module 210 may be configured to receive a notification the courier device 211 may be within a pre-defined geographical area of the origination location. The acceptance confirmation module 230 may be configured to confirm that the courier has accepted a package for delivery. Upon arrival of the courier at the origination location, the courier may take possession of the package. Then, upon confirmation of departure from the origination location, the courier may transport the package to the delivery address. In certain embodiments, the package may include one of a food product and a nonfood product. In certain embodiments, the courier device 211 may be selected from a group including a smartphone 320, a tablet 330, a portable computing device 340, a watch 350, a transceiver 360, and combinations thereof.

The system may be configured for optimizing a delivery, such as described above. In certain embodiments, the system 200 may include one or more computing platforms 202. In particular, the system may be implemented using one or more computing platforms 202 including a computing device such as a smart device, a smart phone, a tablet, a tablet computer, and other appropriately desired computing platforms. The one or more computing platforms 202 may be communicably coupled with one or more remote platforms 204. In some cases, users may access the system 200 via the remote platform(s) 204.

The one or more computing platforms 202 may be configured by machine-readable instructions 206. Machine-readable instructions 206 may implemented within one or more processors 222, and including modules, such as described above. The modules may be implemented as one or more of functional logic, hardware logic, electronic circuitry, software modules, and the like. The modules may include one or more drivers, such as a courier identification module 210 for identifying a courier within a pre-defined geographical area of the origination location, an alerting module 220 for sending an alert to the courier, and an acceptance confirmation module 230 for confirming that a delivery has been accepted.

The one or more modules may also include the arrival confirmation module 240. As described above, the arrival confirmation module 240 may be configured to confirm an arrival of the courier at the origination location. Upon arrival of the courier at the origination location, the courier may take possession of the package. The delivery route populating module 250 may be configured to populate a delivery route for the courier based on a delivery address of the package, and the departure confirmation module 260 may be configured to confirm a departure of the courier and the package from the origination location. Upon confirmation of departure from the origination location, the courier may transport the package to the delivery address. A delivery verification module 270 may be configured to verify a delivery of the package at the delivery address and a return confirmation module 280 may be configured to confirm a return of the courier at the origination location after delivery of the package at the delivery address.

In certain embodiments, the one or more computing platforms 202, may be communicatively coupled to the remote platform(s) 204. In some cases, the communicative coupling may include communicative coupling through a networked environment 226. The networked environment 226 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which the one or more computing platforms 202 and remote platform(s) 204 may be operatively linked via some other communication coupling. The one or more computing platforms 202 may be configured to communicate with the networked environment 226 via wireless or wired connections. In addition, in an embodiment, the one or more computing platforms 202 may be configured to communicate directly with each other via wireless or wired connections. Examples of one or more computing platforms 202 may include, but are not limited to, smartphones, wearable devices, tablets, laptop computers, desktop computers, Internet of Things (IoT) device, or other mobile or stationary devices. In an embodiment, the system 200 may also include one or more hosts or servers, such as the one or more remote platforms 204 connected to the networked environment 226 through wireless or wired connections. According to certain embodiments, the one or more remote platforms 204 may be implemented in or function as base stations (which may also be referred to as Node Bs or evolved Node Bs (eNBs)). In other embodiments, the one or more remote platforms 204 may include web servers, mail servers, application servers, etc. According to certain embodiments, the one or more remote platforms 204 may be standalone servers, networked servers, or an array of servers.

The one or more computing platforms 202 may include one or more processors 222 for processing information and executing instructions or operations. One or more processors 222 may be any type of general or specific purpose processor. In some cases, multiple processors may be utilized according to other embodiments. In fact, the one or more processors 222 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 222 may be remote from the one or more computing platforms 202, such as disposed within a remote platform like the one or more remote platforms 204 of FIG. 2.

The one or more processors 222 may perform functions associated with the operation of system 200 which may include, for example, precoding of antenna gain/phase parameters, encoding and decoding of individual bits forming a communication message, formatting of information, and overall control of the one or more computing platforms 202, including processes related to management of communication resources.

The one or more computing platforms 202 may further include or be coupled to a memory 224 (internal or external), which may be coupled to one or more processors 222, for storing information and instructions that may be executed by one or more processors 222. Memory 224 may be one or more memories and of any type suitable to the local application environment and may be implemented using any suitable volatile or nonvolatile data storage technology such as a semiconductor-based memory device, a magnetic memory device and system, an optical memory device and system, fixed memory, and removable memory. For example, memory 224 may consist of any combination of random access memory (RAM), read only memory (ROM), static storage such as a magnetic or optical disk, hard disk drive (HDD), or any other type of non-transitory machine or computer readable media. The instructions stored in memory 224 may include program instructions or computer program code that, when executed by one or more processors 222, enable the one or more computing platforms 202 to perform tasks as described herein.

In some embodiments, one or more computing platforms 202 may also include or be coupled to one or more antennas for transmitting and receiving signals and/or data to and from one or more computing platforms 202. The one or more antennas may be configured to communicate via, for example, a plurality of radio interfaces that may be coupled to the one or more antennas. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of delivering a package by a courier from an origination location to a delivery address, the method comprising:
providing a delivery system including an origination system in communication with a courier device;
receiving, by the origination system, a notification that the courier is within a pre-defined geographical area of the origination location;
transmitting, by the origination system, an alert to the courier device that a package is available for a delivery at the origination location;
accepting, by the courier, the package for delivery;
receiving, by the origination system, a confirmation that the courier has accepted the delivery;
confirming, by the delivery system, an arrival of the courier at the origination location;
upon confirmation of the courier at the origination location, acquiring the package by the courier;
populating, by the delivery system, a delivery route for the courier based on the delivery address;
confirming, by the delivery system, departure of the courier and the package from the origination location;
transporting, by the courier, the package to the delivery address;
verifying, by the courier, a delivery of the package at the delivery address; and
confirming, by the delivery system, a return of the courier at the origination location after delivery of the package at the delivery address.

2. The method of claim 1, wherein the delivery system further includes a customer device, the customer device in communication with the delivery system.

3. The method of claim 2, wherein the delivery system is configured to send an alert to the customer device that the package has been delivered to the delivery address.

4. The method of claim 3, wherein the alert includes a geographical time stamp.

5. The method of claim 1, wherein acquiring the package by the courier comprises acquiring multiple packages for delivery.

6. The method of claim 5, wherein the delivery route is optimized based on multiple delivery addresses of the multiple packages for delivery.

7. The method of claim 1, wherein acquiring the package by the courier includes scanning a code affixed to the package.

8. The method of claim 7, wherein the code affixed to the package includes a delivery address of the package.

9. The method of claim 8, wherein the delivery route is populated as the code affixed to the package is scanned.

10. The method of claim 1, wherein confirming arrival of the courier at the origination location includes the courier device communicating a location of the courier device to the origination system.

11. The method of claim 1, wherein the courier is pre-approved to deliver the package by the delivery system prior to receiving the notification by the origination system that a package is available for delivery at the origination location.

12. The method of claim 11, wherein the courier is selected from a pool of pre-approved couriers.

13. The method of claim 1, wherein the delivery route is updated based on an environmental condition of the delivery route.

14. The method of claim 1, wherein the origination system populates the delivery route.

15. The method of claim 1, wherein an application of the courier device populates the delivery route.

16. The method of claim 1, further comprising transferring, by the delivery system, a payment to the courier device upon return of the courier at the origination location after delivery of the package at the delivery address.

17. A system for facilitating a delivery of a package by a courier from an origination location to a delivery address, comprising:
a courier identification module in communication with a courier device, wherein the courier identification module is configured to receive a notification the courier device is within a pre-defined geographical area of the origination location;
an alerting module configured to transmit an alert to the courier device that a package is available for a delivery at the origination location;
an acceptance confirmation module configured to receive an acceptance by the courier device of the package for delivery, wherein the confirmation module is configured to confirm that the courier has accepted the package for delivery;
an arrival confirmation module configured to confirm an arrival of the courier at the origination location, wherein upon arrival of the courier at the origination location, the courier takes possession of the package;
a delivery route populating module configured to populate a delivery route for the courier based on a delivery address of the package;
a departure confirmation module configured to confirm a departure of the courier and the package from the origination location, wherein upon confirmation of departure from the origination location, the courier is able to transport the package to the delivery address;
a delivery verification module configured to verify a delivery of the package at the delivery address; and
a return confirmation module configured to confirm a return of the courier at the origination location after delivery of the package at the delivery address.

18. The system for facilitating a delivery of a package by a courier from an origination location to a delivery address of claim 17, wherein the courier device is selected from a group including a smartphone, a tablet, a watch, a portable computing device, a transceiver, and combinations thereof.

19. The system for facilitating a delivery of a package by a courier from an origination location to a delivery address of claim 17, wherein the package includes a non-food product.

20. The system for facilitating a delivery of a package by a courier from an origination location to a delivery address of claim 17, further comprising a payment module configured to transfer a payment to the courier device upon return of the courier at the origination location after delivery of the package at the delivery address.
